(19) United States
(12) Patent Application Publication
(10) Pub. No.: US 2007/0090747 A1
(43) Pub. Date: Apr. 26, 2007

(54) Vacuum envelope, method of manufacturing the vacuum envelope, and electron emission display having the vacuum envelope

(76) Inventors: Dong-Su Chang, Yongin-si (KR); Jae-Young Lee, Yongin-si (KR)

Correspondence Address: CHRISTIE, PARKER & HALE, LLP, PO BOX 7068, PASADENA, CA, 91109-7068, US

(21) Appl. No.: 11/586,319

(22) Filed: Oct. 24, 2006

(30) Foreign Application Priority Data
Oct. 25, 2005 (KR) 10-2005-0100656

(51) Int. Cl. H01J 63/04; H01J 1/62; H01J 9/24; H01J 9/26

(52) U.S. Cl. 313/495; 445/25; 445/24; 313/497

(57) ABSTRACT

A vacuum envelope, a method of manufacturing the vacuum envelope, and an electron emission display having the vacuum envelope. The vacuum envelope includes a first substrate and a second substrate facing the first substrate. A frame is arranged between the first substrate and the second substrate to form an enclosed inner space between the first substrate and the second substrate. At least one supporting member is arranged on one of the first substrate or the second substrate to provide support for the frame.

### CROSS-REFERENCE TO RELATED APPLICATION

This application claims priority to and the benefit of Korean Patent Application No. 10-2005-0100656, filed on Oct. 25, 2005, in the Korean Intellectual Property Office, the entire content of which is incorporated herein by reference.

### BACKGROUND OF THE INVENTION

1. Field of the Invention

The present invention relates to a vacuum envelope, a method of manufacturing the vacuum envelope, and an electron emission display having the vacuum envelope, and more particularly, to a vacuum envelope having a frame fixing structure between a first substrate and a second substrate, a method of manufacturing the vacuum envelope, and an electron emission display having the vacuum envelope.

2. Description of Related Art

In general, electron emission elements can be classified into those using hot cathodes as an electron emission source and those using cold cathodes as an electron emission source.

There are several types of cold cathode electron emission elements, including Field Emitter Array (FEA) elements, Surface Conduction Emitter (SCE) elements, Metal-Insulator-Metal (MIM) elements, and Metal-Insulator-Semiconductor (MIS) elements.

Electron emission elements are arrayed (or arranged) on a first substrate to form an electron emission device. The electron emission device is combined with a second substrate, on which a light emission unit having phosphor layers and an anode electrode is arranged, to make an electron emission display.

That is, a conventional electron emission device includes electron emission regions and a plurality of driving electrodes functioning as scan and data electrodes. By operating the electron emission regions and the driving electrodes, an on/off operation of each pixel and an amount of electron emission are controlled. A conventional electron emission display excites phosphor layers using electrons emitted from the electron emission regions to display a certain (or predetermined) image.

The electron emission display includes a glass frame functioning as a side barrier for forming a vacuum envelope (or chamber).

The glass frame is disposed at respective peripheries of the first substrate and the second substrate and adhered to the first substrate and the second substrate by depositing a frit between the first substrate and the second substrate. Then, a firing process is performed on the glass frame. However, in the firing process, due to heat produced by the firing process, the frit may be in a molten state to have a certain fluidity. Therefore, the glass frame may slip out of a desired position due to the fluidity of the frit. This phenomenon may worsen when there is a presence of a hot current of air (or hot wind) or an occurrence of vibration during the firing process.

The slipping of the glass frame out of the desired position may cause a misalignment of the glass frame between the first substrate and the second substrate.

### SUMMARY OF THE INVENTION

An aspect of the present invention provides a vacuum envelope having a structure for preventing or restraining a glass frame from slipping during a firing process.

Another aspect of the present invention provides a method of manufacturing the vacuum envelope.

Yet another aspect of the present invention provides an electron emission display having the vacuum envelope.

In an embodiment of the present invention, a vacuum envelope includes a first substrate, a second substrate facing the first substrate, a frame arranged between the first substrate and the second substrate to form an enclosed inner space between the first substrate and the second substrate, and at least one supporting member arranged on one of the first substrate or the second substrate to provide support for the frame.

The frame may include a plurality of sections arranged to extend along respective peripheries of the first substrate and the second substrate.

The sections of the frame may include a pair of longitudinal sections and a pair of lateral sections, the longitudinal sections and the lateral sections being coupled to each other to form a rectangular shape.

The at least one supporting member may be arranged at one of an inner surface (e.g. a surface facing toward the vacuum envelope) or an outer surface (e.g. a surface external to the vacuum envelope) of the frame.

The at least one supporting member may include a plurality of members alternately arranged at the inner surface and the outer surface of the frame.

The at least one supporting member may contact the frame.

The at least one supporting member may be spaced apart from the frame by a gap therebetween.

The at least one supporting member may be bonded on one of the first substrate or the second substrate using an adhesive layer.

The adhesive layer may be dried and function as an adhesive at a temperature within a range of from about 50 to about 100° C.

The adhesive layer may be formed of a polymer-based material.

The at least one supporting member may have a height not greater than a height of the frame.

The at least one supporting member may be configured to have a shape of a rectangular post.

In another embodiment of the present invention, an electron emission display includes a first substrate and a second substrate facing the first substrate. An electron emission unit is arranged on the first substrate, and a light emission unit is arranged on the second substrate. A frame is arranged between the first substrate and the second substrate to form an enclosed inner space between the first substrate and the second substrate. At least one supporting member is arranged on one of the first substrate or the second substrate to restrain a movement of the frame.

The electron emission unit may include an electron emission region and a plurality of cathode electrodes. A plurality of gate electrodes may be arranged to cross the cathode electrodes. The cathode electrodes and the gate electrodes may be insulated from each other to control the electron emission region. The light emission unit may include phosphor layers and a black layer arranged between at least two of the phosphor layers, and an anode electrode arranged on the phosphor layers and the black layer.

In another embodiment of the present invention, a method of manufacturing a vacuum envelope includes bonding at least one supporting member on a first substrate using an adhesive layer, aligning a frame with the at least one supporting member, bonding the frame on the first substrate using a first adhesive, and bonding a second substrate on the frame using a second adhesive such that the second substrate faces the first substrate.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an exploded perspective view of a vacuum envelope according to an embodiment of the present invention.

FIG. 2 is a top view of the vacuum envelope shown in FIG. 1.

FIG. 3 is a partial sectional view of the vacuum envelope taken along line A-A of FIG. 2.

FIG. 4 is a top view of a vacuum envelope according to another embodiment of the present invention.

FIG. 5 is a top view of a vacuum envelope according to another embodiment of the present invention.

FIG. 6 is a partial sectional view of an electron emission display having an array of FEA elements according to an embodiment of the present invention.

FIG. 7 is a flowchart illustrating a method of manufacturing a vacuum envelope according to an embodiment of the present invention.

### DETAILED DESCRIPTION

In the following detailed description, only certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, and not restrictive.

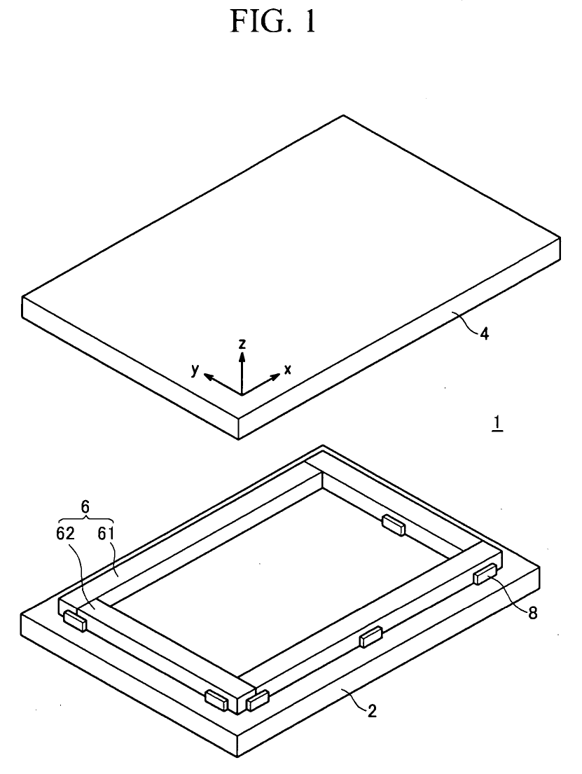

FIGS. 1 through 3 show a vacuum envelope according to an embodiment of the present invention.

Referring to FIGS. 1 through 3, a vacuum envelope (or chamber) 1 includes a first substrate 2 and a second substrate 4 facing the first substrate 2. The first substrate 2 and the second substrate 4 are spaced apart from each other at a certain (or predetermined) interval therebetween. As shown, frames 6 are arranged to extend along respective peripheries (or peripheral regions) of the first substrate 2 and the second substrate 4, thereby forming a vacuum space between the first substrate 2 and the second substrate 4.

The frames 6 include (or are classified into) a pair of longitudinal frames (or sections) 61 and a pair of lateral frames (or sections) 62. That is, the longitudinal frames 61 and the lateral frames 62 are arranged to have a rectangular shape. The frames 6 may be formed of, for example, glass.

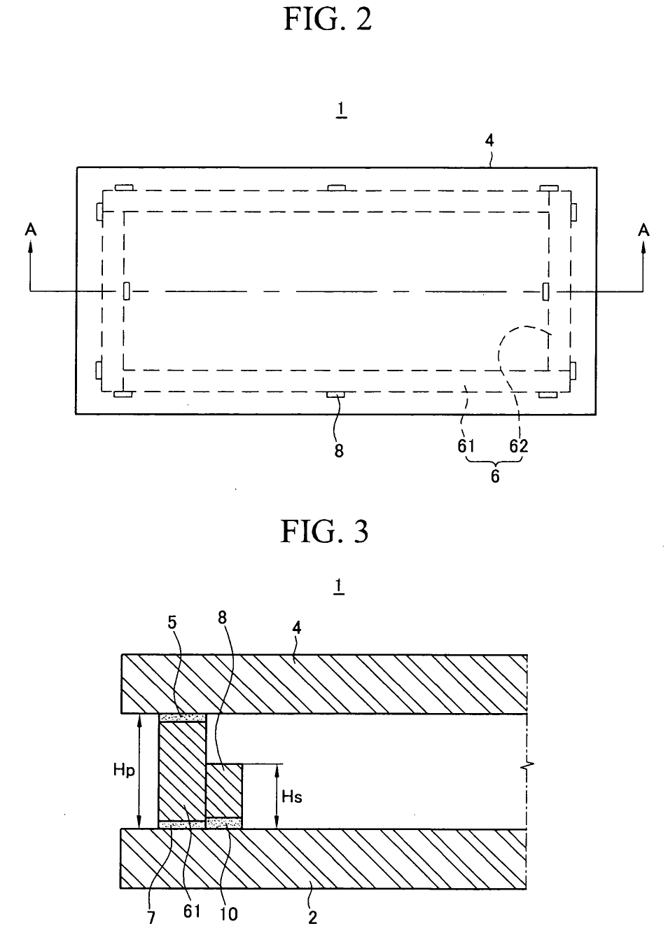

A plurality of supporting members 8 for supporting the frames 6 are arranged on the first substrate 2. As shown in FIG. 2, the supporting members 8 may be arranged on or near inner and/or outer surfaces of the longitudinal frames 61 and the lateral frames 62. Here, the supporting members 8 may closely contact the frames 6 or be spaced apart from the frames 6 by a certain (or predetermined) gap therebetween. In another embodiment, one of the supporting members 8 may be arranged as a single body to extend along a side portion of the frames 6.

When one of the supporting members 8 is arranged to be spaced apart from one of the frames 6, the certain gap between the one of the supporting members 8 and the one of the frames 6 is configured so as to prevent the one of the frames 6 from slipping and to guide an arrangement of the one of the frames 6.

In addition, as shown in FIG. 3, the supporting members 8 may be adhered to the first substrate 2 by an adhesive layer 10. The adhesive layer 10 may be formed of a polymer-based material such as CRC-6050 (Sumiresin Excel®) or sumito.

The adhesive layer 10 may be formed of a material that can be dried and that can function as an adhesive at a temperature within the range from about 50 to about 100° C. At a temperature below 50° C., the adhesive layer 10 may not properly maintain a level of viscosity for adhering the supporting member 8 to the first substrate 2. At a temperature above 100° C., a viscosity of a frit 5 and a frit 7 may be too low, and thus the frames 6 may be moved.

A height H_{S} of the supporting member 8 may be equal to or less than a height H_{P} of the frames 6. If the height H_{S} of the supporting member 8 is greater than the height H_{P} of the frames 6, the first substrate 2, the second substrate 4, and the frames 6 cannot properly form the vacuum envelope. The height H_{S} of the supporting member 8 is configured according to a frame-supporting force and a self-standing property thereof.

In addition, although a case where the supporting member 8 is configured to have a shape of a rectangular post is illustrated, embodiments of the present invention are not limited to this case. By way of example, the supporting member 8 may be configured to have a shape of a circular post or any other suitable shape.

The frit 5 is arranged between the frames 6 and the second substrate 4 to adhere the frames 6 to the second substrate 4. The frit 7 is arranged between the frames 6 and the first substrate 2 to adhere the frames 6 to the first substrate 2.

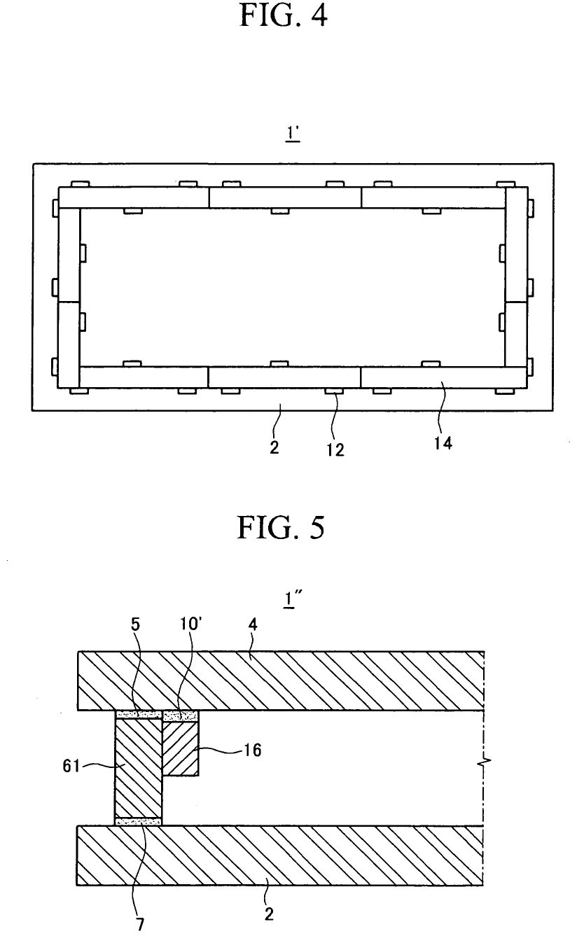

FIG. 4 shows a vacuum envelope 1′ according to another embodiment of the present invention. In this embodiment, two or more frames 14 are provided on each side of the vacuum envelope 1′. A plurality of supporting members 12 are arranged on the first substrate 2 to alternately contact inner side surfaces (within the vacuum envelope 1′) and outer side surfaces (external to the vacuum envelope 1′) of each of the frames 14.

FIG. 5 shows a vacuum envelope 1″ according to another embodiment of the present invention. In this embodiment, a supporting member 16 is adhered to a second substrate 4 by an adhesive layer 10′. That is, in embodiments of the present invention, the supporting member may be affixed on either the first substrate or the second substrate. When the supporting member has a height identical to that of a corresponding frame, the supporting member may be affixed on both the first substrate and the second substrate.

In the embodiments shown in FIGS. 4 and 5, other elements are substantially identical to those in the embodiment shown in FIGS. 1 through 3, and therefore a detailed description thereof will be omitted herein.

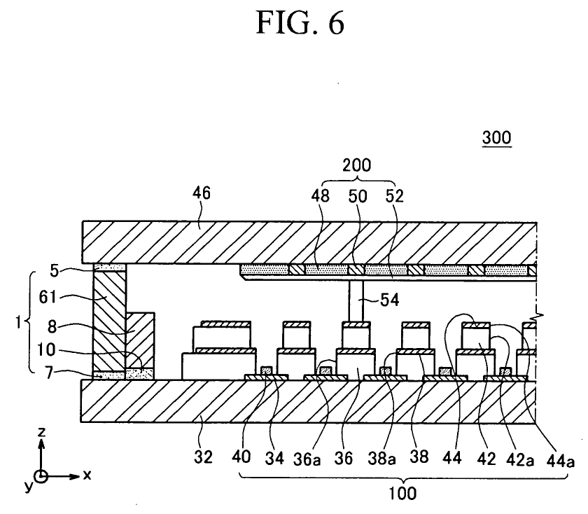

FIG. 6 shows an electron emission display having an array of FEA elements. The embodiment shown in FIG. 6 includes the vacuum envelope 1 shown in FIG. 3.

An electron emission display 300 includes an electron emission unit 100 for emitting electrons and a light emission unit 200 for emitting visible light using the electrons emitted from the electron emission unit 100. The electron emission unit 100 and the light emission unit 200 are arranged in the vacuum envelope 1.

Describing the electron emission unit 100 in more detail, as shown in FIG. 6, a plurality of cathode electrodes 34 are arranged on a first substrate 32 in a striped pattern to extend along a first direction (a direction of a y-axis in FIG. 6) and a first insulation layer 36 is arranged on the first substrate 32 to cover the cathode electrodes 34. A plurality of gate electrodes 38 are arranged on the first insulation layer 36 in a striped pattern to extend along a second direction (a direction of an x-axis in FIG. 6) to cross the cathode electrodes 34 at right angles.

One or more electron emission regions 40 are arranged at the cathode electrodes 34 at each unit pixel area defined by a crossing of the cathode electrodes 34 and the gate electrodes 34 38. A plurality of openings 36a and 38a corresponding to the electron emission regions 40 are respectively arranged on the first insulation layer 36 and the gate electrodes 38 to expose the electron emission regions 40.

The electron emission regions 40 may be formed of a material which emits electrons when an electric field is applied thereto in a vacuum atmosphere. By way of example, the material may be a carbonaceous material and/or a nanometer-sized material. For example, the electron emission regions 40 may be formed of carbon nanotubes, graphite, graphite nanofibers, diamonds, diamond-like carbon, C₆₀, silicon nanowires, and/or combinations thereof.

A second insulation layer 42 is arranged on (or at) the first insulation layer 36 to cover the gate electrodes 38, and a focusing electrode 44 is arranged on the second insulation layer 42. In a manner similar to that described above, in order to expose the electron emission regions 40, openings 42a and 44a are respectively arranged on the second insulation layer 42 and the focusing electrode 44. In general, openings 42a and 44a may be arranged to correspond to each unit pixel area to focus the electrons emitted from each unit pixel area.

Although a case where the gate electrodes 38 are arranged above the cathode electrodes 34 with the first insulation layer 36 interposed therebetween is shown, embodiments of the present invention are not limited to this case. For example, the cathode electrodes may be arranged above the gate electrodes. Correspondingly, the electron emission regions may be arranged on the first insulation layer to contact (or to connect with) the cathode electrodes arranged above the gate electrodes.

Describing the light emission unit 200 in more detail, phosphor layers 48 and black layers 50 for enhancing a contrast of a displayed image are arranged on a surface of a second substrate 46 facing the first substrate 32 (i.e., one of the black layers 50 is arranged between at least two of the phosphor layers 48). An anode electrode 52 formed of a conductive material such as aluminum is arranged on the phosphor layers 48 and the black layers 50.

The anode electrode 52 heightens a screen luminance by receiving a high voltage required for accelerating electron beams and reflecting visible rays radiated from the phosphor layers 48 to the first substrate 32 back toward the second substrate 46.

Arranged between the first substrate 32 and the second substrate 46 are spacers 54 for uniformly maintaining a gap between the first substrate and the second substrate 46.

The above-described electron emission display is driven when certain (or predetermined) voltages are applied to the cathode electrodes 34, the gate electrodes 38, and the anode electrode 52. For example, either the cathode electrodes 34 or the gate electrodes 38 serve as scan electrodes for receiving a scan drive voltage, and the other electrodes function as data electrodes for receiving a data drive voltage. The anode electrode 52 receives a direct current voltage of, for example, hundreds to thousands of volts that can accelerate the electron beams.

Electric fields are formed at or near the electron emission regions 40 at unit pixel areas where a voltage difference between the cathode electrodes 34 and the gate electrodes 38 is equal to or higher than a threshold value, and thus electrons are emitted from the electron emission regions 40. The emitted electrons strike the corresponding phosphor layers 48 via attraction to the direct current voltage applied to the anode electrode 52, thereby exciting the phosphor layers 48.

In the foregoing embodiment, although an electron emission display having an array of FEA elements is illustrated, embodiments of the present invention can also be applied to a vacuum fluorescent display (VFD) as well as to an electron emission display having an array of SCE elements, MIM elements, and/or MIS elements.

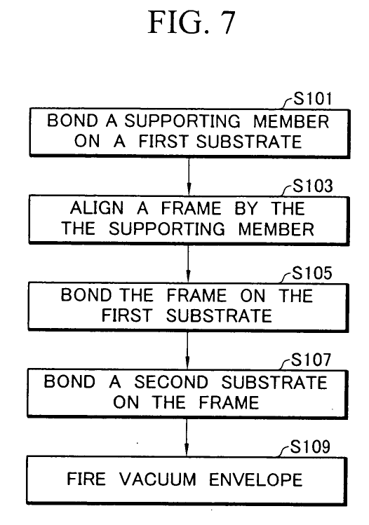

FIG. 7 shows a flowchart illustrating a method of manufacturing the vacuum envelope shown in FIG. 3 according to an embodiment of the present invention.

Referring to FIGS. 3 and 7, the supporting members 8 are first bonded on the first substrate 2 using the adhesive layer 10 (S101), and the frames 6 are arranged on the first substrate 2 while being guided by the supporting members 8 (S103). Then, the frames 6 are bonded on the first substrate 2 using the frit 7 (S105). Then, the second substrate 4 is bonded on the frames 6 to face the first substrate 2 using the frit 5, thereby forming the vacuum envelope 1 (S107). Next, the vacuum envelope is fired (S109).

The frames 6 are arranged along respective peripheries (or peripheral regions) of the first substrate 2 and the second substrate 4. The supporting members 8 may be arranged near inner surfaces or outer surfaces of the frames 6 or alternately arranged near the inner surfaces and the outer surfaces of the frames 6. The supporting members 8 may closely contact the frames 6, and each of the supporting members 8 has a height not greater than that of the frames 6. The supporting member 8 may be configured to have a variety of suitable shapes such as that of a rectangular post or that of a circular post.

According to embodiments of the present invention, since the supporting members are provided to secure positioning of the frames, movement of the frames during a firing of the vacuum envelope can be prevented and/or restrained. Furthermore, since the supporting members serve to guide an alignment of the frames, the frames can be installed more easily.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A vacuum envelope, comprising:
a first substrate;
a second substrate facing the first substrate;
a frame arranged between the first substrate and the second substrate to form an enclosed inner space between the first substrate and the second substrate; and
at least one supporting member arranged on one of the first substrate or the second substrate to provide support for the frame.

2. The vacuum envelope of claim 1, wherein the frame comprises a plurality of sections arranged to extend along respective peripheries of the first substrate and the second substrate.

3. The vacuum envelope of claim 2, wherein the sections of the frame include a pair of longitudinal sections and a pair of lateral sections, the longitudinal sections and the lateral sections being coupled to each other to form a rectangular shape.

4. The vacuum envelope of claim 1, wherein the at least one supporting member is arranged at one of an inner surface or an outer surface of the frame.

5. The vacuum envelope of claim 4, wherein the at least one supporting member comprises a plurality of members alternately arranged at the inner surface and the outer surface of the frame.

6. The vacuum envelope of claim 1, wherein the at least one supporting member contacts the frame.

7. The vacuum envelope of claim 1, wherein the at least one supporting member is spaced apart from the frame by a gap therebetween.

8. The vacuum envelope of claim 1, wherein the at least one supporting member is bonded on one of the first substrate or the second substrate using an adhesive layer.

9. The vacuum envelope of claim 8, wherein the adhesive layer is dried and functions as an adhesive at a temperature within a range of from about 50 to about 100° C.

10. The vacuum envelope of claim 9, wherein the adhesive layer is formed of a polymer-based material.

11. The vacuum envelope of claim 1, wherein the at least one supporting member has a height not greater than a height of the frame.

12. The vacuum envelope of claim 1, wherein the at least one supporting member is configured to have a shape of a rectangular post.

13. An electron emission display, comprising:
a first substrate;
a second substrate facing the first substrate;
an electron emission unit arranged on the first substrate;
a light emission unit arranged on the second substrate;
a frame arranged between the first substrate and the second substrate to form an enclosed inner space between the first substrate and the second substrate; and
at least one supporting member arranged on one of the first substrate or the second substrate to restrain a movement of the frame.

14. The electron emission display of claim 13, wherein the at least one frame comprises a plurality of sections arranged to extend along respective peripheries of the first substrate and the second substrate.

15. The electron emission display of claim 13, wherein the at least one supporting member comprises a plurality of members.

16. The electron emission display of claim 15, wherein the members of the at least one supporting member are arranged at one of an inner surface or an outer surface of the frame.

17. The electron emission display of claim 16, wherein the members of the at least one supporting member are alternately arranged at the inner surface and the outer surface of the frame.

18. The electron emission display of claim 13, wherein the at least one supporting member contacts the frame.

19. The electron emission display of claim 13, wherein the supporting member is bonded on one of the first substrate or the second substrate using an adhesive layer, and wherein the adhesive layer is dried and functions as an adhesive at a temperature within a range of from about 50 to about 100° C.

20. The electron emission display of claim 19, wherein the adhesive layer is formed of a polymer-based material.

21. The electron emission display of claim 13, wherein the at least one supporting member has a height not greater than a height of the frame.

22. The electron emission display of claim 13, wherein the at least one supporting member is configured to have a shape of a rectangular post.

23. The electron emission display of claim 13, wherein the electron emission unit comprises:
an electron emission region;
a plurality of cathode electrodes; and
a plurality of gate electrodes arranged to cross the cathode electrodes,
wherein the cathode electrodes and the gate electrodes are insulated from each other to control the electron emission region, and
wherein the light emission unit comprises phosphor layers, a black layer arranged between at least two of the phosphor layers, and an anode electrode arranged on the phosphor layers and the black layer.

24. The electron emission display of claim 23, wherein the electron emission region comprises a material selected from the group consisting of carbon nanotubes, graphite, graphite nanofibers, diamonds, diamond-like carbon, C₆₀, silicon nanowires, and combinations thereof.

25. A method of manufacturing a vacuum envelope, the method comprising:
bonding at least one supporting member on a first substrate using an adhesive layer;
aligning a frame with the at least one supporting member;
bonding the frame on the first substrate using a first adhesive; and
bonding a second substrate on the frame using a second adhesive such that the second substrate faces the first substrate.

26. The method of claim 25, wherein the first adhesive and the second adhesive are frits.

27. The method of claim 25, wherein the frame comprises a plurality of sections arranged to extend along respective peripheries of the first substrate and the second substrate.

28. The method of claim 25, wherein the at least one supporting member comprises a plurality of members.

29. The method of claim 28, wherein the members of the at least one supporting member are arranged at one of an inner surface or an outer surface of the frame.

30. The method of claim 29, wherein the members of the at least one supporting member are alternately arranged at the inner surface and the outer surface of the frame.

31. The method of claim 25, wherein the at least one supporting member contacts the frame.

32. The method of claim 25, wherein the adhesive layer is formed of a polymer-based material.

33. The method of claim 26, wherein the adhesive layer is dried and functions as an adhesive at a temperature within a range of from about 50 to about 100° C.

34. The method of claim 25, wherein the at least one supporting member has a height not greater than a height of the frame.

35. The method of claim 25, wherein the at least one supporting member is configured to have a shape of a rectangular post.
